(19) United States
(12) Patent Application Publication
(10) Pub. No.: US 2025/0150122 A1
(43) Pub. Date: May 8, 2025

(54) COMMUNICATION DEVICE, CONTROL METHOD, AND RECORDING MEDIUM

(71) Applicant: CANON KABUSHIKI KAISHA, Tokyo (JP)

(72) Inventor: YUKI TSUJIMARU, Kanagawa (JP)

(21) Appl. No.: 19/012,373

(22) Filed: Jan. 7, 2025

Related U.S. Application Data
(63) Continuation of application No. PCT/JP2023/023245, filed on Jun. 23, 2023.

(30) Foreign Application Priority Data
Jul. 8, 2022 (JP) 2022-110742

(51) Int. Cl. H04B 7/0452; H04L 1/20; H04L 27/00; H04W 84/12

(52) U.S. Cl. CPC H04B 7/0452; H04L 1/206; H04L 27/0008; H04W 84/12

(57) ABSTRACT

A communication device performs transmitting, to a server, part or all of information being included in a user selection request, wherein the request requests an inference of quality of communication between the communication device and another communication device in accordance with user selection in Multi-User Multi Input Multi Output (MU-MIMO) communication, acquiring a result of the inference by the server from the server, and preforming MU-MIMO communication with the other communication device based on information acquired from the server.

### CROSS-REFERENCE TO RELATED APPLICATIONS

This application is a Continuation of International Patent Application No. PCT/JP2023/023245, filed Jun. 23, 2023, which claims the benefit of Japanese Patent Application No. 2022-110742, filed Jul. 8, 2022, both of which are hereby incorporated by reference herein in their entirety.

### BACKGROUND

### Technical Field

The present disclosure relates to a communication device that complies with the IEEE 802.11 standards.

### Description of the Related Art

The IEEE 802.11 series of standards are known as communication standards related to wireless local area networks (hereinafter, WLANs). The latest IEEE 802.11be standard uses multi-link technologies to achieve high peak throughput and low delay communication (Japanese Patent Application Laid-Open No. 2018-50133).

In the successor standards to the IEEE 802.11 standards, the introduction of artificial intelligence (AI) and machine learning (ML) is being considered.

On the other hand, the IEEE 802.11 series of standards use a mechanism called Multi Input Multi Output (MIMO) for communication using a plurality of antennas. Further, a mechanism called Multi User-MIMO (MU-MIMO) is used as a method for implementing MIMO for a plurality of terminals.

In MU-MIMO, a sender can simultaneously transmit phase-shifted signals to a plurality of receivers, thereby enabling simultaneous MIMO communication to the plurality of receivers. If there are many receivers in MIMO communication, a user selection method may be used to select a phase allocation with high orthogonality of propagation path in real time according to the state of the propagation path to each receiver to communicate.

In the user selection method, machine learning may be used to determine users and communication parameters to be applied at the time of transmission. However, there has been conventionally no data collection method or learning data usage method for implementing machine learning to infer appropriate user selection in MIMO communication.

### SUMMARY

In view of the above issue, the present disclosure is directed to providing a data collection method and a learning data usage method to achieve optimal user selection with machine learning in MU-MIMO communication.

In view of the above issue, a communication device performs:

transmitting, to a server, part or all of information included in a user selection request, the information being channel matrix information, throughput information, Channel Quality Indicator (CQI) information, communication delay information, communication packet loss rate information, location information of another communication device that has established a connection with the communication device, the number of the other communication devices, intensity of a radio wave received from the other communication device, radio wave condition of a surrounding access point (AP) indicated by the other communication device, surrounding communication condition indicated by the other communication device, frequency band and channel supported by the other communication device, capability information of the surrounding AP, communication bandwidth, information on a Modulation and Coding Scheme (MCS) representing a modulation method, and amount of variation of any piece of the information during a predetermined unit time, wherein the request requests an inference of quality of communication between the communication device and the other communication device in accordance with user selection in Multi-User Multi Input Multi Output (MU-MIMO) communication;
acquiring a result of the inference by the server from the server; and
performing MU-MIMO communication with the other communication device based on information acquired from the server.

Further features of the present invention will become apparent from the following description of exemplary embodiments with reference to the attached drawings.

### BRIEF DESCRIPTION OF THE DRAWINGS

FIG. 1 is a diagram illustrating an example of a network configuration.

FIG. 2 is a diagram illustrating an example of a hardware configuration of an access point (AP)/station (STA).

FIG. 3 is a diagram illustrating functional blocks including the AP and the STA.

FIG. 4 is a conceptual diagram of a structure using a learning model constituted of input data, a learning model, and output data.

FIG. 5 is a diagram illustrating a flow of processing in a system according to the present disclosure.

FIG. 6 is a diagram illustrating a modified example of the flow of processing in the system according to the present disclosure.

FIG. 7 is a flowchart of processing in the AP according to the present disclosure.

FIG. 8 is a flowchart of processing in a data collection server according to the present disclosure.

FIG. 9 is a flowchart of processing in a learning phase in an inference server according to the present disclosure.

FIG. 10 is a diagram illustrating a flowchart of processing in an inference phase in the inference server according to the present disclosure.

FIG. 11 is a diagram illustrating an example of an STA report request frame according to the present disclosure.

FIG. 12 is a diagram illustrating an example of an STA report reply frame according to the present disclosure.

FIG. 13 is a diagram illustrating an example of an STA report classification according to the present disclosure.

### DESCRIPTION OF THE EMBODIMENTS

### First Exemplary Embodiment

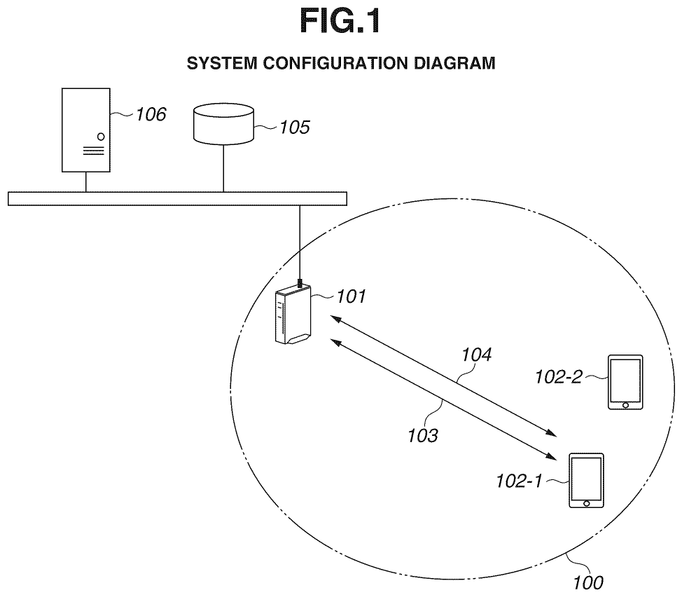

FIG. 1 illustrates an example of a network configuration according to a first exemplary embodiment. A wireless communication system in FIG. 1 is a wireless network including an access point (AP) 101, a station (STA) 102-1, an STA 102-2, a data collection server 105, and an inference server 106. The AP 101 has the same functions as those of the STAs 102-1 and 102-2 except for a relay function, and thus constitutes a form of an STA.

The AP 101 communicates with each STA 102 according to the wireless communication method under the IEEE 802.11 standards. The STAs within a circle 100 indicating the reach of a signal transmitted by the AP 102 can communicate with the AP 101. In the present exemplary embodiment, the AP 101 and each STA 102 communicate according to the IEEE 802.11 standards. The AP 101 establishes wireless links 103 and 104 with the STAs 102 via a predetermined association process or the like. The number of wireless links may be one or more than two.

The AP 101 connects to the data collection server 105 and the inference server 106 via the Internet. The connections between the AP 101 and the data collection server 105 and the inference server 106 may be of any type. The number of STA(s) and AP(s) may be one or more.

The AP 101 and the STAs 102 are capable of wireless communication in accordance with the successor standard to the IEEE 802.11be standard that targets a maximum transmission speed of 46.08 Gbps, and the successor standard targets a maximum transmission speed of 90 Gbps to 100 Gbps or more. This successor standard to 802.11be sets supports for high-reliability communication and low-delay communication as new goals to be achieved. In light of the above, in the present exemplary embodiment, the successor standard to IEEE 802.11be, which targets a maximum transmission speed of 90 Gbps to 100 Gbps or more, will be provisionally named IEEE 802.11 High Reliability (HR).

The name IEEE802.11 HR is a name given for convenience in consideration of the goals and features of the successor standard, and may be a different name when the standard is finalized. However, it should be noted that the present specification and the appended claims are essentially applicable to all successor standards to the 802.11be standard that can support wireless communication.

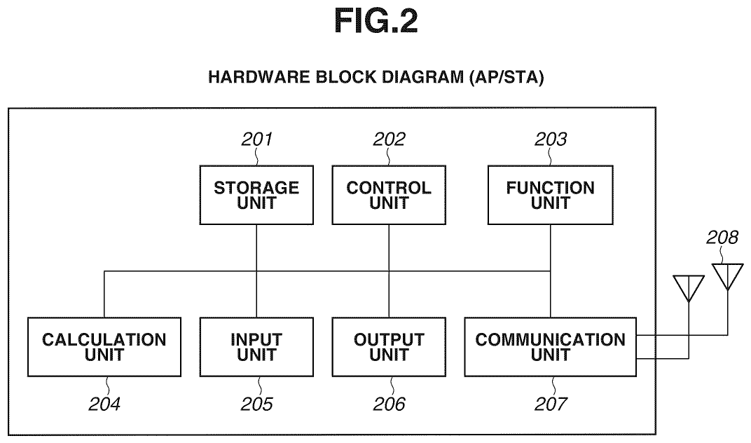

FIG. 2 illustrates a hardware configuration of the AP/STA according to the present disclosure. As an example of a hardware configuration, the AP/STA includes a storage unit 201, a control unit 202, a function unit 203, a calculation unit 204, an input unit 205, an output unit 206, a communication unit 207, and an antenna 208.

The storage unit 201 is constituted of memories such as a read only memory (ROM) and a random access memory (RAM), and stores various types of information such as programs for performing various operations described below and communication parameters for wireless communication. Instead of the memories such as a ROM and a RAM, the storage unit 201 may be a storage medium such as a flexible disk, a hard disk, an optical disk, a magneto-optical disk, a compact disc-ROM (CD-ROM), a CD recordable (CD-R), a magnetic tape, a non-volatile memory card, or a digital versatile disc (DVD). Further, the storage unit 201 may include a plurality of memories.

The control unit 202 is constituted of a processor such as a central processing unit (CPU) or a micro processing unit (MPU), an application specific integrated circuit (ASIC), a digital signal processor (DSP), a field programmable gate array (FPGA), or the like, for example. The control unit 202 controls the AP 101 by executing a program stored in the storage unit 201.

The control unit 202 may control the AP 101 with cooperation between a program stored in the storage unit 201 and an operating system (OS). The control unit 202 may also be constituted of a plurality of processors including multi-core processor or the like to control the AP 101.

The control unit 202 controls the function unit 203 to execute the AP functions and predetermined processes such as image capture, printing, and projection. The function unit 203 is hardware that enables the AP 101 to execute the predetermined processes.

The calculation unit 204 is constituted of a processor such as a graphics processing unit (GPU) or a Tensor processing unit (TPU), an ASIC, a DSP, an FPGA, or the like, for example. The calculation unit 204 is hardware for inferring machine learning results and for calculating the machine learning itself. These processors perform calculations in collaboration with the control unit 202, so that they may share some calculations. Since a GPU can perform efficient calculations by processing more data in parallel, it is effective to use the GPU in performing learning a plurality of times using a learning model performing deep learning. Thus, in the present exemplary embodiment, a GPU is used as the calculation unit 204 as well as the control unit 202 for processing by the learning unit of the inference server. Specifically, in the case of executing a learning program including a learning model, the control unit 202 and the calculation unit 204 cooperate to perform calculations in learning. The processing of the learning unit may be performed only by the control unit 202 or the calculation unit 204. The inference unit may also use the calculation unit 204, like the learning unit.

In the example of FIG. 1, a data collection server and an inference server used for machine learning are prepared separately from the AP 101. However, the AP 101 or the STA 102 itself may perform machine learning.

The input unit 205 accepts various operations from the user. The output unit 206 produces various types of output to the user. The output by the output unit 206 here includes at least one of display on a screen, sound output by a speaker, vibration output, and the like. Both the input unit 205 and the output unit 206 may be implemented by a single module, such as a touch panel.

The communication unit 207 performs encoding, decoding, modulation, and demodulation processing of wireless communication data in conformity with the IEEE 802.11 HR standard, control of wireless communication in conformity with Wi-Fi, and control of Internet Protocol (IP) communication. The communication unit 207 further controls the antenna 208 to transmit and receive wireless signals for wireless communication.

If a data collection server and an inference server used for machine learning are prepared separately from the AP 101 and the STA 102, the servers are each constituted of a von Neumann computer. More specifically, each server has one or more memories and one or more processors corresponding to the control unit 202, and has computation resources such as a GPU or TPU corresponding to the calculation unit 204. In this case, the GPU or TPU of the server operates as hardware for performing inference computation using the results of machine learning, or for computing the machine learning itself.

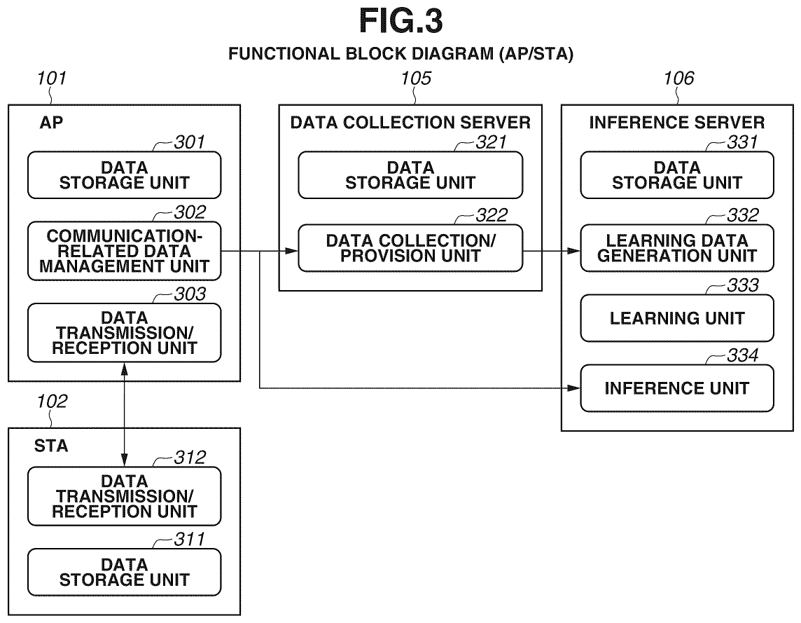

FIG. 3 illustrates functional blocks of the learning system according to the present disclosure.

The STA 102 has a data transmission/reception unit 312, and transmits and receives surrounding information collected by the communication unit 207, its own information, and information accumulated in the storage unit 201, via the communication unit 207 and the antenna 208. The data storage unit 311 uses the storage unit 201.

The AP 101 has a data transmission/reception unit 303 that receives data transmitted by the STA 102, and also transmits data from the AP 101 to the STA 102. These operations are performed using the communication unit 207 and the antenna 208. In addition, the AP 101 has a data storage unit 301 that stores data in the storage unit 201. The AP 101 also develops the storage unit 201 and the control unit 202 and provides a communication-related data management unit 302. The communication-related data management unit 302 cooperates with the data collection server 105 and the inference server 106, transmits input data required for learning, receives inference results, and communicates requests therefor.

The data collection server 105 accumulates data collected from the AP 101 and other APs in a data storage unit 321. The data collection server 105 also transmits the data accumulated in the inference server 106 as necessary using a data collection/provision unit 322.

The inference server 106 receives the input information and result data obtained from the data collection server 105, and generates a learning model using a learning data generation unit 332 and a learning unit 333. The generated learning model is stored in a data storage unit 331. Upon receipt of a request for an inferred value from the AP 101, the inference server 106 calculates an inferred value using the results of learning by an inference unit 334, and returns the results to the AP 101.

Once the inference server 106 generates a learning model based on the received input and output data, the inference server 106 may transmit the learning model to the AP 101.

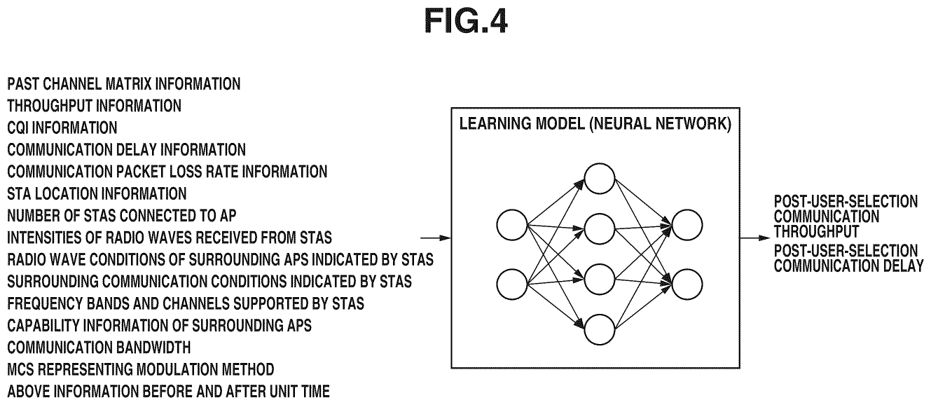

FIG. 4 is a conceptual diagram illustrating an input/output structure using a learning model according to the present exemplary embodiment.

Examples of input data to the learning model include past channel matrix information, throughput information, Channel Quality Indicator (CQI) information, communication delay information, communication packet loss rate information, STA location information, the number of STA(s) connected to the AP, and radio wave intensity received from the STA connected to the AP. In addition, the input data to the learning model may include radio wave conditions of surrounding APs and surrounding communication conditions indicated by the STA connected to the AP, corresponding frequency bands and channels of the STA connected to the AP, capability information of surrounding APs, Modulation and Coding Scheme (MCS) representing the bandwidth and modulation method during communication, and the like. Alternatively, the input data may be communication throughput and communication delay required by an application, for example. Alternatively, the input data may be the amount of fluctuations in the above information for a predetermined unit time based on a certain time, that is, time series data of the above information. For example, there may be data sets as in Table 1 below.

TABLE 1
Examples of Data Sets of Input Data and Training Data

| | | | | | | | Training data | | |
|---|---|---|---|---|---|---|---|---|---|
| | Input data | | | | | | | Post-user- | |
| | | | | Packet | | | Post-user- | selection | |
| Learning | AP | STA | | loss | | | selection | communication | |
| data ID | ID | ID | Throughput | rate | Delay | . . . | throughput | delay | . . . |
| 1 | 101 | 102 | 190 Mbps | 0.001 | 0.04 sec | . . . | 204 Mbps | 0.02 sec | . . . |
| 2 | 101 | 107 | 168 Mbps | 0.015 | 0.18 sec | . . . | 183 Mbps | 0.13 sec | . . . |
| 3 | 108 | 110 | 175 Mbps | 0.004 | 0.11 sec | . . . | 172 Mbps | 0.12 sec | . . . |
| . . . | . . . | . . . | . . . | . . . | . . . | . . . | . . . | . . . | . . . |
| N | 170 | 197 | 187 Mbps | 0.003 | 0.09 sec | . . . | 190 Mbps | 0.08 sec | . . . |

The STA location information may be information on the relative distance to the AP101 and the distance to the surrounding APs, or may be location information acquired by a global positioning system (GPS). For example, the location information may be N35° 21.636′, E138° 43.640′, and altitude 3775.6 m. The STA location information may also be movement data for a predetermined unit time not only in the present but also in the past. Alternatively, the STA location information may be information such as the movement direction or movement speed. The positional relationship between the surrounding APs and the AP 101 may be the relative distance and positional relationship with each AP that are obtained by extracting APs located close to the AP101, for example, within 50 m. Alternatively information such as the distance to a wall near the location where the AP101 is placed may be used. As candidates for the surrounding APs, the top five APs close to the coordinates acquired from the STA location information may be used, for example. The STA location information five minutes later predicted from the current STA location information may be used. Alternatively, the AP candidates may be APs from which the AP101 and the STA 102 can actually receive radio waves. In this case, the AP 101 or the server may narrow down all the candidates to APs that operate with the same extended service set identifier (ESSID).

The communication throughput and communication delay required by an application may be specific numerical values or may be step-wise numerical values.

The results of past user selections may be used for learning as learning result data or may be used as a reward for reinforcement learning. At the time of user selection, if communication throughput increases or communication delay decreases, the user selection may be considered to be successful, so that the user selection may be recommended or a high reward may be set. Only one of the two indicators may be considered as an indicator for recommending the user selection, or a different indicator such as radio wave intensity may be used.

The learning results are used as material for inferring communication throughput and communication delay at the time of user selection. The inferred values after user selection may be compared with the current actual data to determine whether the user selection result is good or bad. If it is determined that there is an improvement in the values compared to the current values, the user selection results are recommended. The results may also be stored as data for learning.

Specific examples of machine learning algorithms include nearest neighbor methods, naive Bayes methods, decision trees, and support vector machines. Alternatively, reinforcement learning methods such as the Monte Carlo method may be used. Also included is deep learning, which uses a neural network to generate features and connection weighting coefficients for learning. Alternatively, any available one of the above algorithms can be used as appropriate and applied to the present exemplary embodiment.

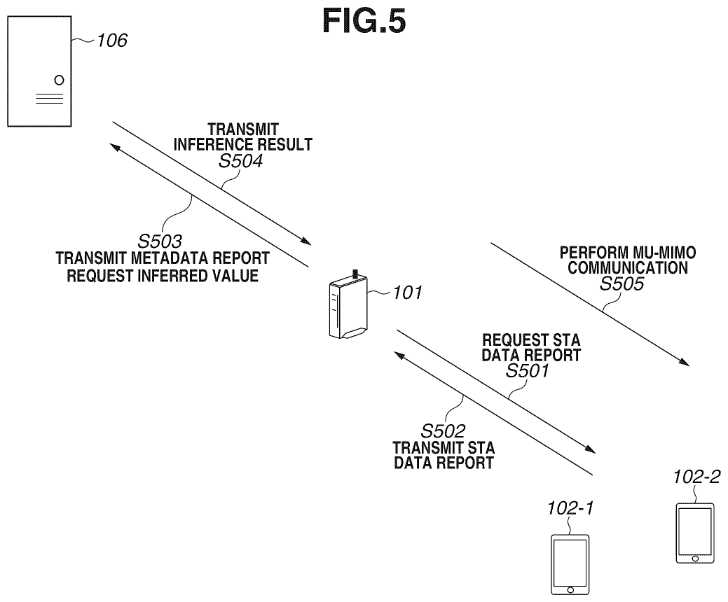

FIG. 5 is a diagram for describing the operations of a system to which the present disclosure can be applied, which utilizes the structure of the learning model illustrated in FIG. 4.

First, in step S501, the AP 101 requests a report of STA data from the STA 102. The STA data requested here is information to be used as input data for the learning and inference illustrated in FIG. 4, such as the surrounding environment and location information of the STA 102. For example, the information includes STA location information, surrounding APs from which radio waves can be received and their radio wave intensities, capability information, radio wave reception strength of the AP 101, and the like.

In step S502, the STA 102 transmits a report of the STA data in response to the request from the AP 101.

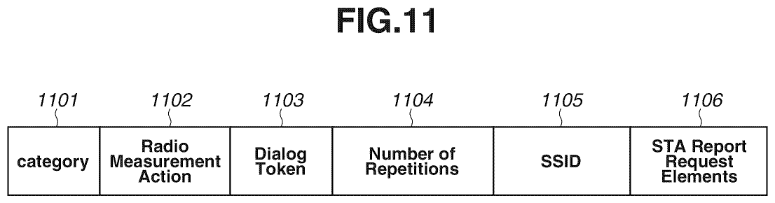

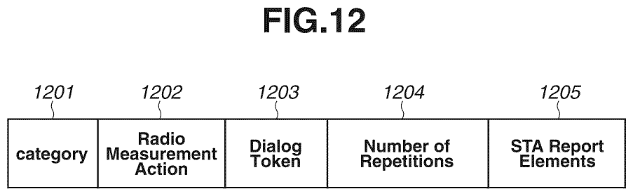

FIGS. 11 and 12 illustrate examples of newly defined frames used in making a request and a response for the collection of STA data. In the present exemplary embodiment, in step S501, a newly defined STA Report Request is transmitted at the time of making a request for a report of STA data. In addition, a STA Report Response is newly defined as a response to the STA Report Request.

The request frame in step S501 includes Category 1101, Radio Measurement Action 1102, Number Of Repetitions 1104, SSID 1105, and STA Report Request Elements 1106.

The Category 1101 includes information indicating that the frame is an Action frame. The IEEE 802.11 standards specify that “5” is included as information indicating an Action frame.

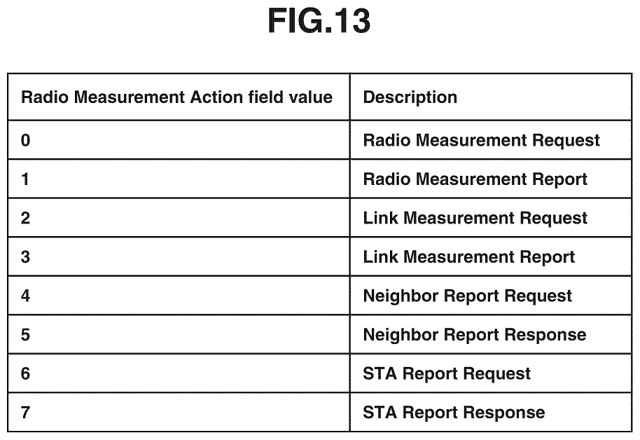

The Radio Measurement Action 1102 includes any of values illustrated in FIG. 13. This field indicates which of the types of information illustrated in FIG. 13 is being requested. In the case of requesting information required for machine learning, 6 is included in this field to indicate that this is an STA Report Request.

The Number of Repetitions 1104 includes a value indicating how many times the report is desired to be performed.

The SSID 1105 indicates the SSID of the AP the report of which the device transmitting the frame wishes to be performed.

The STA Report Request Elements 1106 indicates the type of information which causes the STA 102 to respond. For example, if it is desired to receive STA location information, information on surrounding APs that can receive radio waves, and capability information of the surrounding APs, the corresponding bits are set to 1 to make a request. The request transmitted in step S501 may use a Radio Measurement Action frame defined in IEEE 802.11k, for example. As examples of the Radio Measurement Action frame, Radio Measurement Request, Link Measurement Request, or Neighbor Report Request may be used.

As illustrated in FIG. 12, the response frame in step S502 includes Category 1201, Radio Measurement Action 1202, Number of Repetitions 1204, and STA Report Elements 1205.

The information stored in the Category 1201 is similar to that illustrated in FIG. 11, and thus a description thereof will be omitted.

The Radio Measurement Action 1202 has a value of 7 therein to indicate that the response is an STA Report Response to the STA report request.

The Number Of Repetitions 1204 and STA Report Elements 1205 are similar to those illustrated in FIG. 11, and thus description thereof will be omitted.

In the STA Report Elements 1205, information matching the requested information is added and transmitted. As the report transmitted in step S502, the Radio Measurement Action frame may be used, for example. As examples of the Radio Measurement Action frame, Radio Measurement Report, Link Measurement Report, or Neighbor Report Response may be used.

Returning to the description of FIG. 5, after the AP 101 collects information from the STA 102 as described above, in step S503, the AP 101 transmits the information, including its own measured data as metadata, to the inference server 106. In step S504, the inference server 106 returns to the AP 101, the inferred values of communication throughput and communication delay after user selection from the input data. The AP 101 determines the user selection based on the received inferred values and the current actual measured values. Based on the user selection determined here, the AP 101 performs Multi-User Multi Input Multi Output (MU-MIMO) communication with each STA 102.

In the present exemplary embodiment, a method for acquiring information for use in machine learning by an STA data report request or an STA data report transmission is used. However, the present invention is not limited to this method. For example, channel sounding or calibration in MU-MIMO may be performed, and the information transmitted and received there may be used for machine learning, or the information may be used together with the results of machine learning to perform user selection. In addition, the information for use in machine learning may be acquired by communicating the MIMO Control field of the HT Action frame already specified in the IEEE802.11 standards, and the information may be used together with the results of machine learning to perform user selection. In the above example, the HT Action frame is used, but the VHT MIMO Control field of the VHT Action frame or the EHT MIMO Control field of the EHT Action frame, which are already specified in the IEEE802.11 standards may be used.

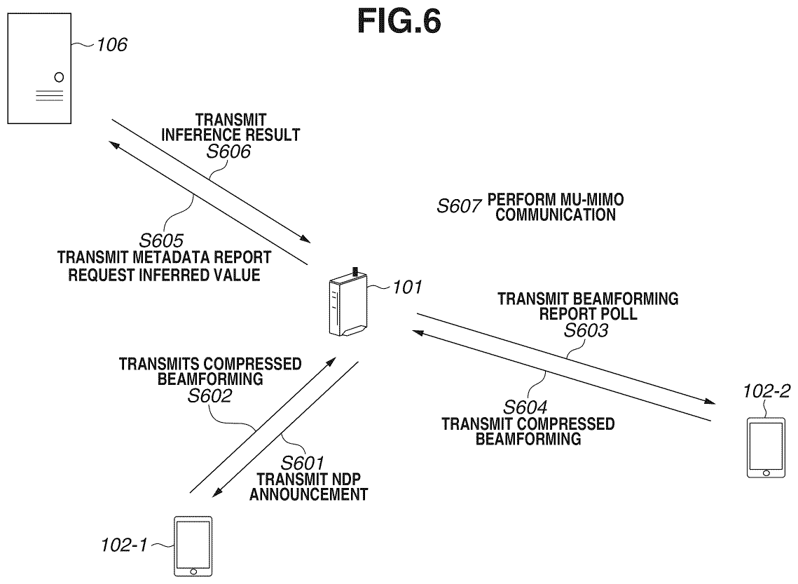

As an example, FIG. 6 illustrates the operations of the system in the case of performing channel sounding. First, in step S601, the AP 101 transmits a NDP Announcement to the STA 102-1. In step S602, the STA 102-1 transmits a Compressed Beamforming in response to the request from the AP 101. In step S603, the AP 101, which has received the Compressed Beamforming, transmits a Beamforming Report Poll to the STA 102-2. In step S604, the STA 102-2 transmits a Compressed Beamforming in response to this request from the AP 101. In step S605, the AP 101, which has received the Compressed Beamforming from the STAs with which the AP 101 will perform MIMO communication, transmits the data including its own measured data as metadata to the inference server 106. In step S606, the inference server 106 returns to the AP 101, the inferred values of communication throughput and communication delay after user selection from the input data. The AP 101 determines the user selection, which is the devices with which the AP 101 will communicate, based on the received inferred values and the current actual measured values. In step S607, based on the user selection determined here, the AP 101 performs MU-MIMO communication with each STA 102.

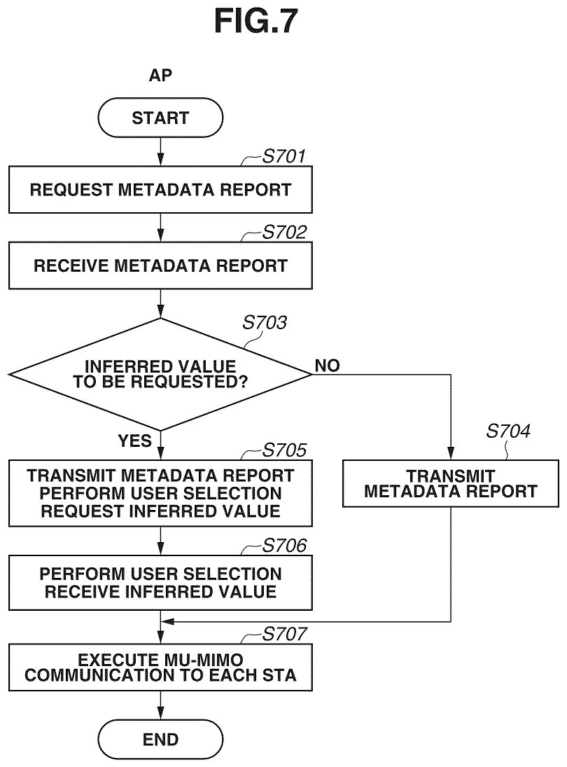

FIG. 7 is a flowchart illustrating a flow of processing performed by the control unit 202 executing a program stored in the storage unit 201 of the AP 101 during learning and inference according to the present disclosure.

This processing is started at regular intervals after the AP 101 starts a connection with the STA 102. In step S701, the AP 101 requests STA data from the STA 102. This is implemented in step S501 in FIG. 5. In step S702, the AP 101 receives a response to the request. In step S703, the AP 101 determines whether to request an inferred value of user selection from the inference server 106 using the STA data received in step S702. If the AP 101 determined in step S703 that an inference is not to be requested (NO in step S703), in step S704, the AP 101 transmits the collected metadata to the data collection server 105. If the AP 101 determined in step S703 that an inference is to be requested (YES in step S703), in step S705, the AP 101 transmits a metadata report to the inference server 106, and in step S706, the AP 101 receives a response to the inferred value. In step S707, based on the user selection result received in step S706, the AP 101 starts MU-MIMO communication.

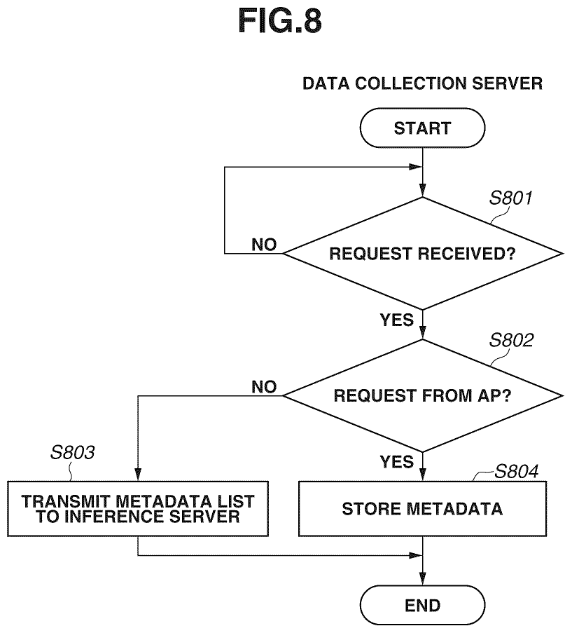

FIG. 8 is a flowchart illustrating a flow of processing by the data collection server 105 during learning and inference. This processing is always executed by the data collection server 105.

In step S801, the data collection server 105 waits for a request from the AP 101 or the inference server 106. Upon receipt of a request in step S801, in step S802, the data collection server 105 determines whether the request is from the AP 101. That is, in step S802, the processing is changed depending on the sender of the request. If the data collection server 105 determines in step S802 that the request is from the inference server 106 (NO in step S802), in step S803, the data collection server 105 determines that the request is a request for a learning data list, and transmits a recorded metadata list to the inference server 106. If the data collection server 105 determines in step S802 that the request is from the AP 101 (YES in step S802), in step S804, the data collection server 105 determines that the request is a request for metadata recording on the data collection server 105, and stores the metadata.

The determination criterion does not have to be the sender address. For example, the request details may be described in the request frame.

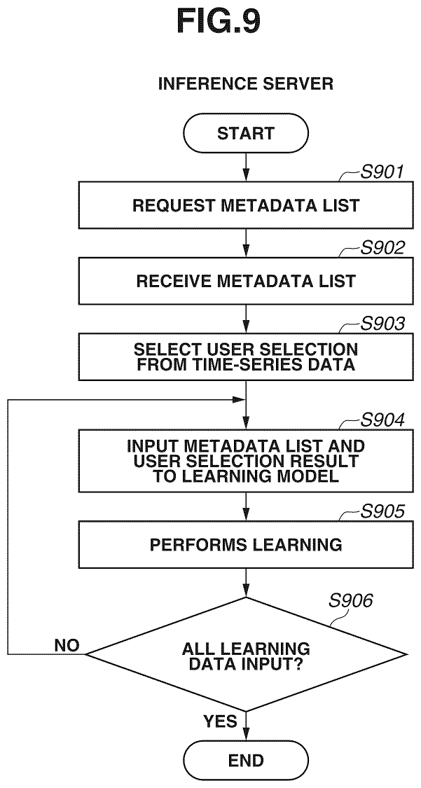

FIG. 9 is a flowchart illustrating a flow of processing by the inference server 106 during learning.

The learning of the inference server may be performed on a periodic basis, or may be performed after an inference request is received from the AP 101 and an inferred value is output.

In step S901, the inference server 106 requests a metadata list from the data collection server 105. In step S902, the inference server 106 receives the metadata list from the data collection server 105. In step S903, the inference server 106 selects a user selection result from the time-series data. In the present exemplary embodiment, the result data includes the post-user-selection communication throughput and the post-user-selection communication delay, but the result data may include other data. For example, the result data may be a post-user-selection channel matrix of MU-MIMO communication with each STA. The input data may be all data during a certain continuous period. For example, the input data may be data obtained by sampling data every minute from the past 10 minutes of data and collecting the data.

In step S904, the inference server 106 inputs the results of user selection and the metadata to the learning model. In step S905, the inference server 106 performs learning. In step S906, the inference server 106 repeats this processing until all the learning data has been input.

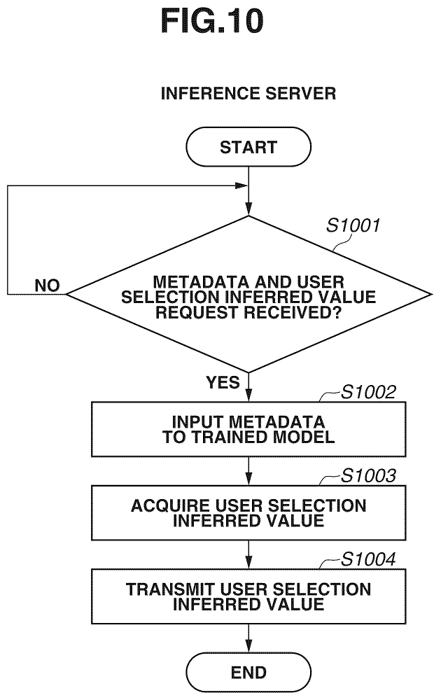

FIG. 10 is a flowchart illustrating a flow of processing by the inference server 106 during inference. This processing is assumed to be executed at all times.

First, in step S1001, the inference server 106 determines whether it has received input data and a user selection inferred value request from the AP 101.

If the inference server 106 determines in step S1001 that a request has been received (YES in step S1001), in step S1002, the inference server 106 inputs the input data to the trained model. At this time, if the received metadata is provided in a format different from that of the input data, the inference server 106 uses the learning data generation unit 332 to convert the received metadata into the input data format.

In step S1003, the inference server 106 then obtains an inferred value from the learning model. In step S1004, the inference server 106 returns the obtained inferred value to the AP 101.

After the learning model is generated by the processing in FIG. 8, the learning model may be distributed from the inference server 106 to all target APs such as the AP 101. In this case, the processing in this figure is performed inside the AP 101. At this time, after obtaining the user selection inferred value, the AP 101 performs MU-MIMO communication based on the inferred value.

In this manner, while using frames defined in the IEEE 802.11 standards, the AP 101 can use artificial intelligence (AI) and machine learning (ML) to perform appropriate user selection from among the STAs with which a connection has been established, and can carry out MU-MIMO communication based on that selection.

The character strings corresponding to the standard names such as IEEE802.11 HR and the standard names constituting the field names including the same character strings as the standard names typified by HR-SIG, HR-STF, and HR-LTF are not limited to the above ones. Examples of the character strings include High Reliability (HRL), High Reliability Wireless (HRW), Very High Reliability (VHT), Extremely High Reliability (EHR), Ultra High Reliability (UHR), Low Latency (LL), Very Low Latency (VLL), Extremely Low Latency (ELL), and Ultra Low Latency (ULL).

Examples of the character strings further include High Reliable and Low Latency (HRLL), Ultra-Reliable and Low Latency (URLL), Ultra-Reliable and Low Latency Communications (URLLC). For example, in the case of using UHR, the field name is constituted of a character string corresponding to the standard name, such as UHR-SIG, UHR-STF, or UHR-LTF, which imitates the standard. Alternatively, other names may be used.

A recording medium on which the program codes of software for implementing the above-described functions are recorded may be supplied to a system or a device, and the computer (CPU, MPU) of the system or device may read and execute the program codes stored in the recording medium. In this case, the program codes read from the storage medium implement the functions of the above-described exemplary embodiment, and the storage medium in which the program codes are stored constitutes the above-described device.

Examples of the storage medium for supplying the program codes include a flexible disk, a hard disk, an optical disk, a magneto-optical disk, a CD-ROM, a CD-R, a magnetic tape, a non-volatile memory card, a ROM, and a DVD.

The above-described functions may be implemented not only by the computer executing the read program codes, but also by an operating system (OS) running on the computer and performing all or part of actual processing based on the instructions of the program codes.

The program codes read from the storage medium are written into a memory provided on a function expansion board inserted into the computer or a function expansion unit connected to the computer.

Then, based on instructions of the program codes, a CPU provided in the function expansion board or function expansion unit may carry out part or all of the actual processing to implement the above-described functions.

According to the present disclosure, there is provided a data collection method and a learning data usage method to achieve optimal user selection using machine learning in MU-MIMO communication.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device comprising:
at least one memory storing instructions; and
at least one processor configured to execute the instructions stored in the at least one memory to cause the communication device to perform:
transmitting, to a server, part or all of information being included in a user selection request, the information being channel matrix information, throughput information, Channel Quality Indicator (CQI) information, communication delay information, communication packet loss rate information, location information of another communication device that has established a connection with the communication device, the number of the other communication devices, intensity of a radio wave received from the other communication device, radio wave condition of a surrounding access point (AP) indicated by the other communication device, surrounding communication condition indicated by the other communication device, frequency band and channel supported by the other communication device, capability information of the surrounding AP, communication bandwidth, information on a Modulation and Coding Scheme (MCS) representing a modulation method, and amount of variation of any piece of the information during a predetermined unit time,
wherein the request requests an inference of quality of communication between the communication device and the other communication device in accordance with user selection in Multi-User Multi Input Multi Output (MU-MIMO) communication;
acquiring a result of the inference by the server from the server; and
performing MU-MIMO communication with the other communication device based on information acquired from the server.

2. The communication device according to claim 1, wherein the information is communicated by an Action frame conforming to an IEEE 802.11 standard.

3. A communication method of a communication device, comprising:
transmitting, to a server, part or all of information being included in a user selection request, the information being channel matrix information, throughput information, CQI information, communication delay information, communication packet loss rate information, location information of another communication device that has established a connection with the communication device, the number of the other communication devices, intensity of a radio wave received from the other communication device, radio wave condition of a surrounding AP indicated by the other communication device, surrounding communication condition indicated by the other communication device, frequency band and channel supported by the other communication device, capability information of the surrounding AP, communication bandwidth, information on an MCS representing a modulation method, and amount of variation of any piece of the information during a predetermined unit time,
wherein the request requests an inference of quality of communication between the communication device and the other communication device in accordance with user selection in MU-MIMO communication;
acquiring from the server a result of the inference by the server; and
performing MU-MIMO communication with the other communication device based on information acquired from the server.

4. A non-transitory computer readable storage medium storing a program to cause a computer to perform:
transmitting, to a server, part or all of information being included in a user selection request, the information being channel matrix information, throughput information, CQI information, communication delay information, communication packet loss rate information, location information of another communication device that has established a connection with the communication device, the number of the other communication devices, intensity of a radio wave received from the other communication device, radio wave condition of a surrounding AP indicated by the other communication device, surrounding communication condition indicated by the other communication device, frequency band and channel supported by the other communication device, capability information of the surrounding AP, communication bandwidth, information on an MCS representing a modulation method, and amount of variation of any piece of the information during a predetermined unit time,
wherein the request requests an inference of quality of communication between the communication device and the other communication device in accordance with user selection in MU-MIMO communication;
acquiring a result of the inference by the server from the server; and
performing MU-MIMO communication with the other communication device based on information acquired from the server.
